(19) United States
(12) Patent Application Publication
(10) Pub. No.: US 2024/0372308 A1
(43) Pub. Date: Nov. 7, 2024

(54) METHOD FOR PRODUCING A CONTACT UNIT, AND CONTACT UNIT

(71) Applicant: KG PHOENIX CONTACT GMBH & CO. KG, Blomberg (DE)

(72) Inventors: Karsten Krome, Detmold (DE); Mirko Vandieken, Schieder- Schwalenberg (DE); Benjamin Monzer, Bad Pyrmont (DE); Tobias Schau, Lemgo (DE)

(21) Appl. No.: 18/552,688

(22) PCT Filed: Mar. 25, 2022
(86) PCT No.: PCT/EP2022/057958

§ 371 Date: Sep. 27, 2023

(30) Foreign Application Priority Data
Apr. 1, 2021 (BE) BE2021/5252

(51) Int. Cl. H01R 43/20; H01R 13/41; H01R 13/506

(52) U.S. Cl. CPC H01R 43/20; H01R 13/41; H01R 13/506

(57) ABSTRACT

A method for producing a contact unit having at least two contact elements includes: providing a first contact element carrier, which is formed from a first carrier material, such that, in the first carrier material, at least one contact element is received on a receiving portion of the at least one contact element, and the first carrier material has been at least partially shrink-fitted on the receiving portion; providing a second contact element carrier, which is formed from a second carrier material, such that the second contact element carrier receives the first contact element carrier in a longitudinal direction; introducing, at least in sections, the first contact element carrier into the second contact element carrier up to an assembly position of the first contact element carrier; and attaching at least one reference contact element to the second contact element carrier.

### CROSS-REFERENCE TO PRIOR APPLICATIONS

This application is a U.S. National Phase application under 35 U.S.C. § 371 of International Application No. PCT/EP2022/057958, filed on Mar. 25, 2022, and claims benefit to Belgian Patent Application No. BE 2021/5252, filed on Apr. 1, 2021. The International Application was published in German on Oct. 6, 2022 as WO/2022/207498 under PCT Article 21(2).

### FIELD

The present invention relates to a method for producing an electrical contact unit, and to a contact unit which has preferably been produced by the method.

### BACKGROUND

If electrically-conductive metal contact elements are to be overmolded with plastic materials during the production of electrical contact units, additional measures must often be taken in order to ensure a firm anchoring, i.e., fastening of the contact elements relative to the overmolded plastic body—especially after the overmolding process. One design measure is, for example, the formation of embossments, projections, recesses, flanges, or so-called “rear grip” geometries. After the overmolding process, it must be ensured in any case that displacement of the contact elements relative to the overmolded plastic body as carrier body is no longer possible.

One challenge during overmolding is to achieve an exact or defined position of the contact element relative to the overmolded plastic body, which, aside from the production process, is also due to relatively large tolerances of the individual components.

In order, for example, to achieve narrow tolerance specifications with respect to coplanarity in so-called SMD (surface-mounted device) products, the contact elements are often not overmolded, but, rather, pressed into the already existing carrier material in a positionally accurate manner, or are subsequently permanently deformed when overmolding is nevertheless carried out. However, narrow and necessary tolerance specifications can be achieved only with increased effort during production. Correspondingly required measuring instruments and special processes during assembly lead to increased production costs.

The published European patent application EP 1 357 774 A1 discloses a method for producing a conductor structure with an electronic component, which conductor structure is overmolded with plastic. The conductor structure is inserted with the electronic component fixed thereto into an injection mold and is then overmolded with a thermoplastic in an overmolding process. In order to protect the electronic component, the electronic component is provided with a two-part envelope having a closure prior to the overmolding process.

Furthermore, the published European patent application EP 0 383 025 A1 describes a method for encapsulating electrical or electronic components and assemblies, which are accommodated in a two-part housing, wherein connection contacts are guided outwards from the housing. To increase the sealing effect and as protection against internal corrosion, an outer capsule made of a thermoplastic is molded onto the housing by injection molding in the region of the joints of the housing and in the exit region of the connection contacts.

### SUMMARY

In an embodiment, the present invention provides a method for producing a contact unit having at least two contact elements, comprising: providing a first contact element carrier, which is formed from a first carrier material, such that, in the first carrier material, at least one contact element is received on a receiving portion of the at least one contact element, and the first carrier material has been at least partially shrink-fitted on the receiving portion: providing a second contact element carrier, which is formed from a second carrier material, such that the second contact element carrier is configured to receive the first contact element carrier in a longitudinal direction: introducing, at least in sections, the first contact element carrier into the second contact element carrier up to an assembly position of the first contact element carrier: attaching at least one reference contact element to the second contact element carrier: and moving the at least one contact element in the first contact element carrier to an end position, such that, in the end position, at least one surface portion of the at least one contact element and at least one surface portion of the at least one reference contact element are arranged coplanarly.

### BRIEF DESCRIPTION OF THE DRAWINGS

The present invention will be described in even greater detail below based on the exemplary figures. The invention is not limited to the exemplary embodiments. Other features and advantages of various embodiments of the present invention will become apparent by reading the following detailed description with reference to the attached drawings which illustrate the following:

FIG. 1A shows a perspectival view of a first contact element carrier of a first exemplary embodiment of the contact unit according to the present invention:

FIG. 1B shows a front view of the first contact element carrier shown in FIG. 1A:

FIG. 1C shows a side view (side view from the left) of the first contact element carrier shown in FIG. 1B:

FIG. 1D shows a plan view of the first contact element carrier shown in FIG. 1B:

FIG. 1E shows a sectional view (section A-A in FIG. 1D) of the first contact

element carrier shown in FIG. 1B:

FIG. 2 shows an exploded view of a first exemplary embodiment of the contact unit according to the present invention:

FIG. 3 shows a further exploded view of the contact unit shown in FIG. 2:

FIG. 4A shows a side view of the contact unit shown in FIGS. 2 and 3, wherein the contact unit is in an assembly state:

FIG. 4B shows a sectional view (section B-B in FIG. 4A) of the contact unit shown in FIG. 4A with a schematically illustrated pressing tool:

FIG. 4C shows a front view of the contact unit shown in FIG. 4A with a schematically illustrated pressing tool:

FIG. 5A shows a side view of the contact unit shown in FIGS. 2 and 3, wherein the contact unit is in a manufactured state:

FIG. 5B shows a sectional view (section C-C in FIG. 5A) of the contact unit shown in FIG. 5A with a schematically illustrated pressing tool:

FIG. 5C shows a front view of the contact unit shown in FIG. 5A with a schematically illustrated pressing tool:

FIG. 6 shows a sequence of an exemplary embodiment of the method according to the present invention:

FIG. 7A shows a front view and a side view (side view from the left) of a first contact element carrier of a second exemplary embodiment of the contact unit according to the present invention:

FIG. 7B shows a front view and a side view (side view from the left) of a first contact element carrier of a third exemplary embodiment of the contact unit according to the present invention;

FIG. 7C shows a front view and a side view (side view from the left) of a first contact element carrier of a fourth exemplary embodiment of the contact unit according to the present invention:

FIG. 7D shows a front view and a side view (side view from the left) of a first contact element carrier of a fifth exemplary embodiment of the contact unit according to the present invention.

### DETAILED DESCRIPTION

In an embodiment, the present invention provides an improved method for producing a contact unit, which method is characterized, in particular, without complex use of measuring instruments at least during the production of the contact unit. A further object of the present invention is to provide an improved contact unit in which, in particular, coplanarity at least of surfaces of the contact elements is ensured regardless of their individual tolerances and/or manufacturing tolerances after production, and, above all, tolerances are minimized.

According to a first, general aspect, the invention relates to a method for producing a contact unit—preferably an SMD contact unit—having at least two contact elements, comprising: providing a first contact element carrier, which is formed from a first carrier material, wherein, in the first carrier material, at least one contact element is received on a receiving portion of the at least one contact element, and the first carrier material has been at least partially shrink-fitted on the receiving portion: providing a second contact element carrier, which is formed from a second carrier material, wherein the second contact element carrier is designed to receive—preferably receive at least in a positive and/or nonpositive manner—the first contact element carrier substantially in a longitudinal direction: introducing, at least in sections, the first contact element carrier into the second contact element carrier—preferably substantially in the longitudinal direction—up to an assembly position of the first contact element carrier—preferably up to a stop of the second contact element carrier—wherein the stop is preferably arranged and/or formed in the second contact element carrier: attaching at least one reference contact element to the second contact element carrier: moving the at least one contact element—preferably substantially in the longitudinal direction—in the first contact element carrier to an end position, wherein, in the end position, at least one surface portion of the at least one contact element and at least one surface portion of the at least one reference contact element are arranged substantially coplanarly.

By means of the method according to the present invention, it is possible to compensate in particular for tolerances and deviations of individual elements themselves and of sub-components after their production. Furthermore, for example, it is also possible to dispense with the use of complex measuring instruments during production of the contact unit.

The first carrier material can preferably be an electrically non-conductive, sprayable, and/or pourable carrier material, such as, for example, plastic material. The second carrier material can preferably be an electrically non-conductive, sprayable, and/or pourable carrier material, such as, for example, plastic material. Preferably, the first carrier material and the second carrier material can be identical.

According to a further aspect of the invention, it may be provided that moving the at least one contact element comprise pressing the at least one contact element at least in sections in and/or at least in sections through the first contact element carrier by means of a pressing tool. As a result, it is possible, for example, to position and/or align the at least one contact element with sufficient accuracy and, by complying with required or predetermined tolerances, preferably relative to the at least one reference contact element, in order to substantially achieve a corresponding coplanarity.

Alternatively, it is possible that moving the at least one contact element comprises pulling the at least one contact element—preferably substantially in the longitudinal direction and with a clamping tool.

It is possible that moving the at least one contact element—preferably pressing the at least one contact element—is done by means of a pressing tool and until the pressing tool comes into contact with at least one stop—preferably with a surface portion of the at least one stop—wherein the at least one stop is formed and/or arranged on the second contact element carrier—preferably a contact element stop of the at least one reference contact element. The pressing tool can preferably have corresponding actuating surfaces which are arranged substantially coplanarly. The pressing tool can preferably be made of a metallic material with correspondingly high strength and/or stiffness.

According to a further aspect of the invention, it may be provided that attaching the at least one reference contact element comprise pressing the at least one reference contact element—preferably substantially perpendicularly or substantially transversely to the longitudinal direction—at least in sections onto or at least in sections into a fastening portion of the second contact element carrier—preferably in order to press on or press in the at least one reference contact element. Thus, for example, a positive and primarily nonpositive connection can be formed between the second contact element carrier and the at least one reference contact element.

It is possible that introducing, at least in sections, the first contact element carrier into the second contact element carrier comprises plugging and/or sliding the first contact element carrier along at least one guide channel of the second contact element carrier—preferably substantially in the longitudinal direction, and preferably up to a contact element carrier stop of the second contact element carrier. The reaching or contacting of the contact element carrier stop by the first contact element carrier can constitute an assembly position.

According to a further aspect of the invention, it may be provided for the method to comprise: forming, at least in sections, at least a nonpositive connection—preferably at least a crimped connection—between the first contact element carrier and the second contact element carrier—preferably at least in the assembly position.

According to a further aspect of the invention, it may be provided for the method to further comprise:

forming, at least in sections, at least a positive connection—preferably at least a latching connection—between the first contact element carrier and the second contact element carrier—preferably in the assembly position.

It is possible that introducing, at least in sections, the first contact element carrier into the second contact element carrier up to the assembly position comprises: aligning a guide portion of the at least one contact element by passing the at least one contact element—preferably substantially in the longitudinal direction—through at least one guide sleeve of the second contact element carrier. Aligning can comprise a plastic (permanent) or an elastic deformation of the at least one contact element. The guide sleeve can be formed substantially in the longitudinal direction. Alternatively, it is possible for the guide sleeve to be designed to be oblique relative to the longitudinal direction in order to guide the guide portion of the at least one contact element into a position and/or orientation that is oblique relative to the longitudinal direction.

According to a second general aspect, the invention relates to a contact unit with a first contact element carrier and preferably with a second contact element carrier, wherein the contact unit is preferably produced according to a method as disclosed herein, wherein the first contact element carrier is formed from a first carrier material, wherein, in the first carrier material, at least one contact element is received on a receiving portion of the at least one contact element, wherein the first carrier material has been at least partially shrink-fitted on the receiving portion in order to support the at least one contact element in the first carrier material in a dimensionally-stable manner, wherein at least the receiving portion is formed in a pin-shaped and/or undercut-free manner substantially in a longitudinal direction.

In other words, the receiving portion is preferably free of formations, projections, recesses, flanges, etc., so that movability of the at least one contact element relative to the first carrier material is ensured or exists in one direction—preferably substantially in the longitudinal direction.

It is possible for the at least one contact element to be formed in a pin-shaped and/or undercut-free manner substantially in the longitudinal direction.

According to a further aspect of the invention, it can be provided for at least the receiving portion—preferably the at least one contact element—to have a substantially rectangular, a substantially square, a substantially round, a substantially trapezoidal, a substantially triangular, an oval, or a polygonal cross-section in the longitudinal direction.

According to a further aspect of the invention, it can be provided for the first contact element carrier to be received substantially in the longitudinal direction in a second contact element carrier, wherein the second contact element carrier is formed from a second carrier material on which at least one reference contact element is attached, wherein at least one surface portion of the at least one contact element and at least one surface portion of the at least one reference contact element are arranged substantially coplanarly.

It is possible for the at least one contact element to have an actuating portion which extends substantially transversely to the longitudinal direction and has the at least one surface portion, wherein preferably the at least one surface portion is formed to be substantially planar or substantially flat.

According to a further aspect of the invention, it can be provided for the first contact element carrier to have a first contact element and a second contact element, wherein the first contact element is arranged at a distance from and/or opposite the second contact element, and is preferably formed and/or arranged substantially mirror-symmetrically to a plane: and/or wherein the second contact element carrier has a first reference contact element and a second reference contact element, wherein the first reference contact element is arranged at a distance from and/or opposite the second reference contact element, and is preferably formed and/or arranged substantially mirror-symmetrically to a plane.

Preferably, the first contact element can be formed substantially identically or at least similarly to the second contact element.

According to a further aspect of the invention, it can be provided that, substantially in the longitudinal direction, the receiving portion extend more than 70% of the total length of the at least one contact element in the longitudinal direction. This ensures, for example, sufficient holding or support of the at least one contact element in the by the first carrier material.

The invention can, for example, provide a contact unit in which two contact elements in the first carrier body are arranged and aligned with respect to one another such that, together with further reference contact elements, compliance with corresponding tolerances is ensured. This is required, for example, in SMD applications.

To avoid repetition, features directed purely towards the device of the contact unit according to the invention and/or disclosed in conjunction therewith should also be considered to be disclosed and be able to be claimed in accordance with the method, and vice versa.

Identical or functionally equivalent components or elements are denoted by the same reference signs in the figures. For the explanation thereof, reference is also made in part to the description of other exemplary embodiments and/or figures in order to avoid repetition.

The following detailed description of the exemplary embodiments illustrated in the figures serves for more detailed illustration or clarification and is not intended to limit the scope of the present invention in any way.

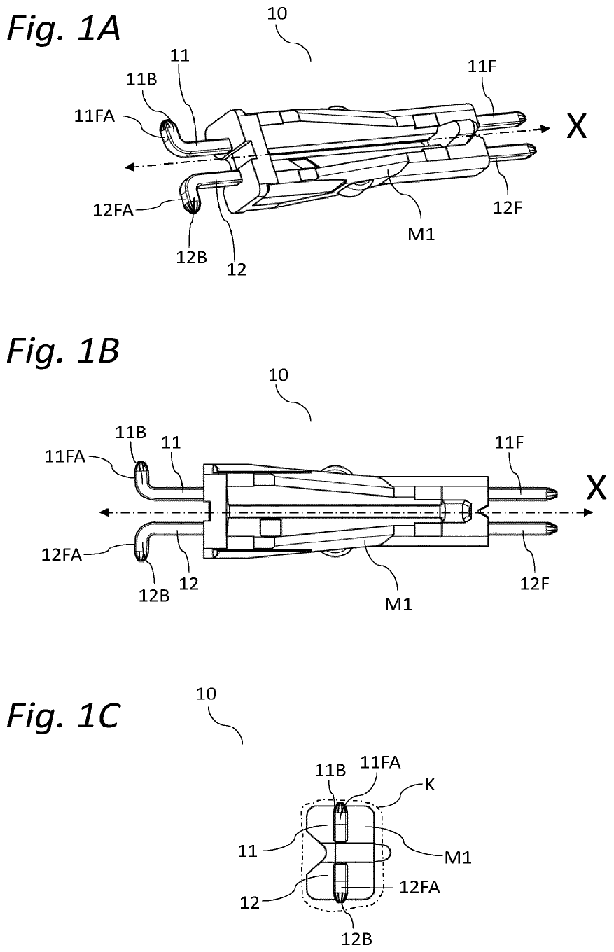

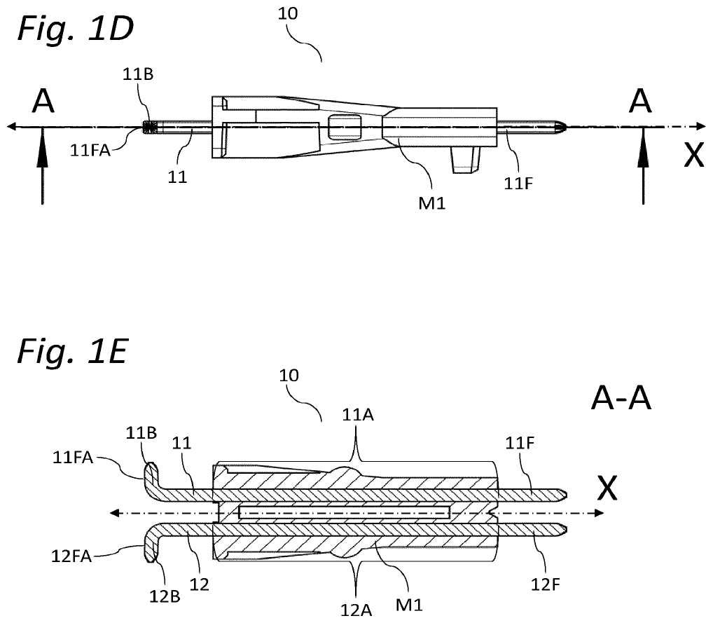

Before an exemplary embodiment of the method according to the present invention is described, a first exemplary embodiment of the device according to the invention, i.e., of the contact unit and individual components and elements of the contact unit, will be described in more detail with reference to FIGS. 1A through 5C.

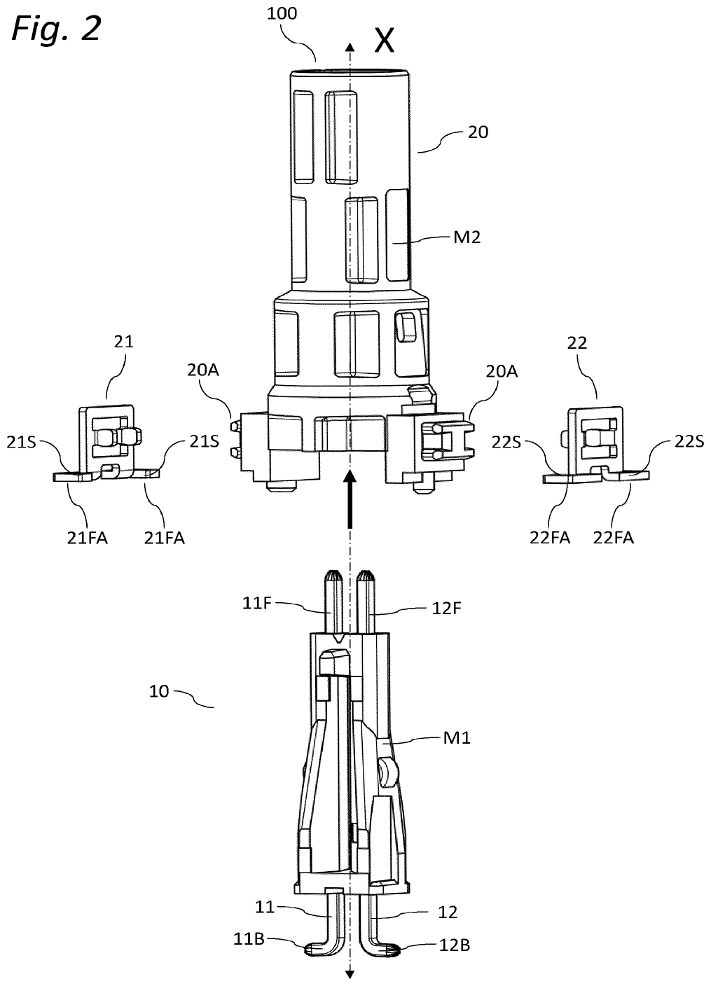

FIG. 1A shows a perspectival view of a first contact element carrier 10 of a first exemplary embodiment of the contact unit 100 according to the present invention (see the further FIGS. 2 through 5C in this regard).

The first contact element carrier 10 substantially comprises a carrier body for electrically-conductive contact elements 11, 12, wherein the carrier body is produced from a first carrier material M1. The first carrier material M1 is preferably at least a sprayable and/or at least a pourable material—for example, a plastic material with an electrically-insulating effect. In other words, the first carrier material M1 is preferably at least a sprayable and/or at least a pourable insulating material which is not electrically conductive. In order to make the first carrier material M1 at least sprayable and/or at least pourable, it may be subjected, for example, to a melting process.

The first carrier material M1, which forms the carrier body, accommodates two contact elements 11, 12, which are electrically conductive. The contact elements 11, 12 serve for transmitting electrical signals and/or electrical energy. Both the first contact element 11 and the second contact element 12 are produced from an electrically-conductive material—preferably a metallic material. The metallic material of the contact elements 11, 12 can be copper and/or a copper alloy, for example. Furthermore, the metallic material can be plastically (permanently) deformable at least in sections or can be elastically deformable at least in sections.

Both the first contact element 11 and the second contact element 12 extend along a longitudinal direction X through the first carrier material M1. In other words, the first contact element 11 and the second contact element 12 extend correspondingly in the longitudinal direction X away from the first carrier material M1 on opposite end faces of end surfaces of the first carrier material M1.

The first contact element 11 comprises on a first end face a guide portion 11F, and the second contact element 12 comprises on this first end face a guide portion 12F, which will be described in more detail below with respect to its function. In addition, the first contact element 11 comprises an actuating portion 11B on a second end face of the first carrier material M1, which is formed opposite the first end face in the longitudinal direction X. Analogously to the first contact element 11, the second contact element 12 also comprises an actuating portion 12B on this second end face.

The actuating portion 11B comprises a tip at a free end of contact element 11, and the actuating portion 12B comprises a tip at a free end of contact element 12. The contact elements 11, 12 are arranged in the first contact element carrier 10 and are positioned at a distance from one another such that the free ends, i.e., the tips of contact elements 11, 12, point in opposite directions, each preferably substantially transversely to the longitudinal direction X. It is possible for the actuating elements 11B, 12B to be arranged and/or formed differently, which will be described in more detail below with reference to further figures.

Furthermore, the actuating portion 11B comprises a surface portion 11FA, and the actuating portion 12B comprises a surface portion 12FA. Although surface portion 11FA as well as surface portion 12FA are each formed to be substantially planar or substantially flat, the production of the first contact element carrier 10 in advance of the production of contact unit 100—especially during production y means of overmolding the contact elements 11, 12 of the first contact element carrier 10—makes it impossible to comply with the required or predetermined tolerances—preferably with respect to coplanarity of surface portions 11FA and 12FA relative to each other—at least not for a plurality of first contact element carriers 10. This is required, for example, in the production of printed circuit boards by means of SMD (surface-mounted device) technology, since otherwise satisfactory electrical connections between contact unit 100, i.e., between contact elements of a contact unit 100 and a printed circuit board, cannot be formed. For example, due to excessively large tolerances during a soldering process, undesired cavities can arise between the printed circuit board and the contact unit 100, which should be avoided.

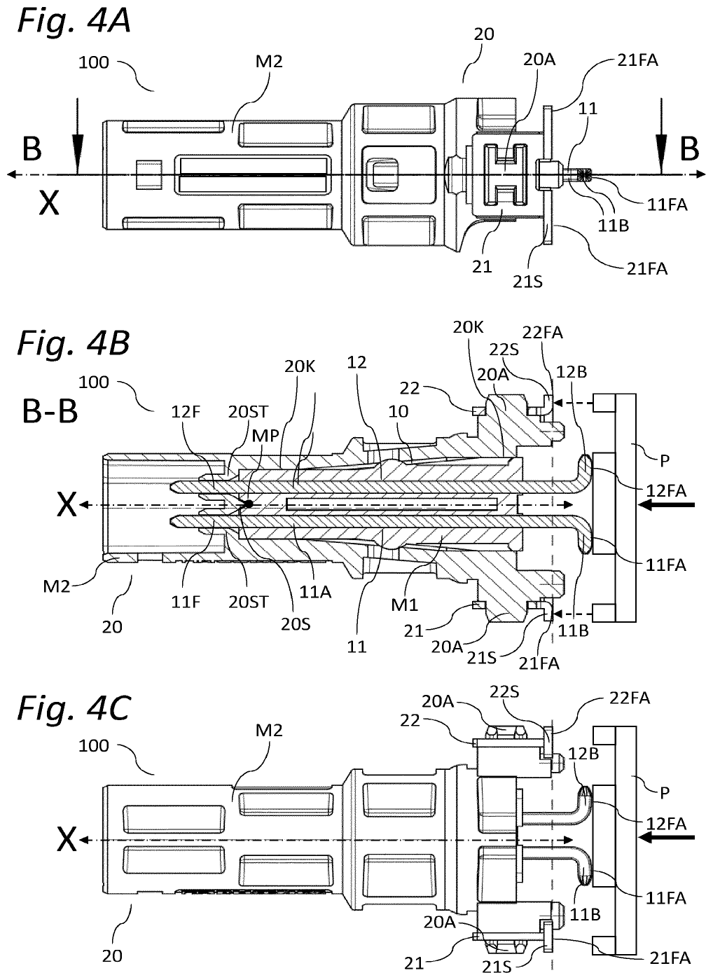

Surface portion 11FA as well as surface portion 12FA are each used as a stop for a pressing tool P (see above all FIGS. 4B and 4C as well as 5B and 5C) in order to move the first contact element 11 and/or the second contact element 12—preferably to press the first contact element 11 and/or the second contact element 12 into and/or through the first carrier material M1 in the longitudinal direction X, i.e., to press it in, which will be described in more detail below with reference to further figures.

FIG. 1B shows a front view of the first contact element carrier 10 shown in Fig. 1A. In the longitudinal direction X, the first carrier material M1 is cuboid at least in sections and/or is formed at least in sections with a continuously tapering cross-section, and is preferably formed to substantially taper from the second end face of the first carrier material M1 in the direction of the first end face of the first carrier material M1.

FIG. 1C shows a side view (side view from the left) of the first contact element carrier 10 shown in FIG. 1B. In this view, the first contact element carrier 10 and preferably the first carrier material M1 have a substantially rectangular contour K.

FIG. 1D shows a plan view of the first contact element carrier 10 shown in FIG. 1B. Compared with its cross-section, the first contact element carrier 10 is substantially extending in the longitudinal direction X.

FIG. 1E shows a sectional view (section A-A in FIG. 1D) of the first contact element carrier 10 shown in FIG. 1B. The sectional view shows that both the first contact element 11 and the second contact element 12 extend continuously through the first carrier material M1 in the longitudinal direction X. The first contact element 11 and the second contact element 12 are substantially pin-shaped. Preferably, at least the receiving portion 11A of the first contact element 11 and the receiving portion 12A of the second contact element 12, which in each case contact the first carrier material M1 and/or are received in the first carrier material M1, are substantially pin-shaped. The first contact element 11 is held and/or supported by the first carrier material M1 via receiving portion 11A, and the second contact element 12 is also held and/or supported by the first carrier material M1 via its receiving portion 12A. Receiving portion 11A and receiving portion 12A are at least overmolded by the first carrier material M1 in order to support and/or hold the first contact element 11 and the second contact element 12 in a dimensionally-stable manner. Preferably, a material connection in the form of an adhesive connection is formed between receiving portion 11A and/or between receiving portion 12A and the first carrier material M1.

Both at least receiving portion 11A and receiving portion 12A are formed without undercuts—preferably in the longitudinal direction X. In other words, at least receiving portion 11A and at least receiving portion 12A are free from formations, projections, recesses, flanges, or similar “rear grip” geometries, which, in the longitudinal direction X, would prevent movability of contact elements 11, 12 relative to the first carrier material M1.

Due to the pin-shaped design of contact elements 11, 12 with a preferably substantially square cross-section, it is possible to move contact elements 11, 12 in a non-destructive manner relative to the first carrier material M1, which is preferably plastic material as disclosed herein—for example, by means of pressing (pushing operation) or by means of pulling contact elements 11, 12. It is also possible to move, i.e., to displace, contact elements 11, 12, which are received in the first carrier material M1, relative to the first carrier material M1, by pushing them. As an alternative to a substantially square cross-section, contact elements 11, 12 can have a substantially rectangular cross-section or a substantially round cross-section—preferably in the region of receiving portions 11A, 12A.

As is apparent from the combination of FIGS. 1A through 1E, the first contact element 11 is arranged at a distance from and opposite the second contact element 12—preferably in the first carrier material Ml of the first contact element carrier 10—and these are preferably arranged and/or formed symmetrically to a plane. Actuating portion 11B extends in sections substantially transversely to receiving portion 11A, and actuating portion 12B extends in sections substantially transversely to receiving portion 12A. Actuating portions 11B, 12B on contact elements 11, 12 are preferably formed by deformation, e.g., by bending, preferably before being positioned and/or aligned in an assembly device, i.e., in the assembly injection mold for producing the first contact element carrier 10. Overall, contact elements 11, 12 can be produced independently and separately before at least one overmolding process and/or before at least one casting process with the first carrier material M1. The first carrier material M1 is preferably designed as a solid and/or integrally-formed body.

FIG. 2 shows an exploded view of a first exemplary embodiment of the contact unit 100. The contact unit 100 comprises a first contact element carrier 10 and a second contact element carrier 20. The second contact element carrier 20 is formed from a second carrier material M2. The second carrier material M2 can be identical to the first carrier material M1—preferably as disclosed herein. Alternatively, it is possible for the second carrier material M2 to be a different material than the first carrier material M1.

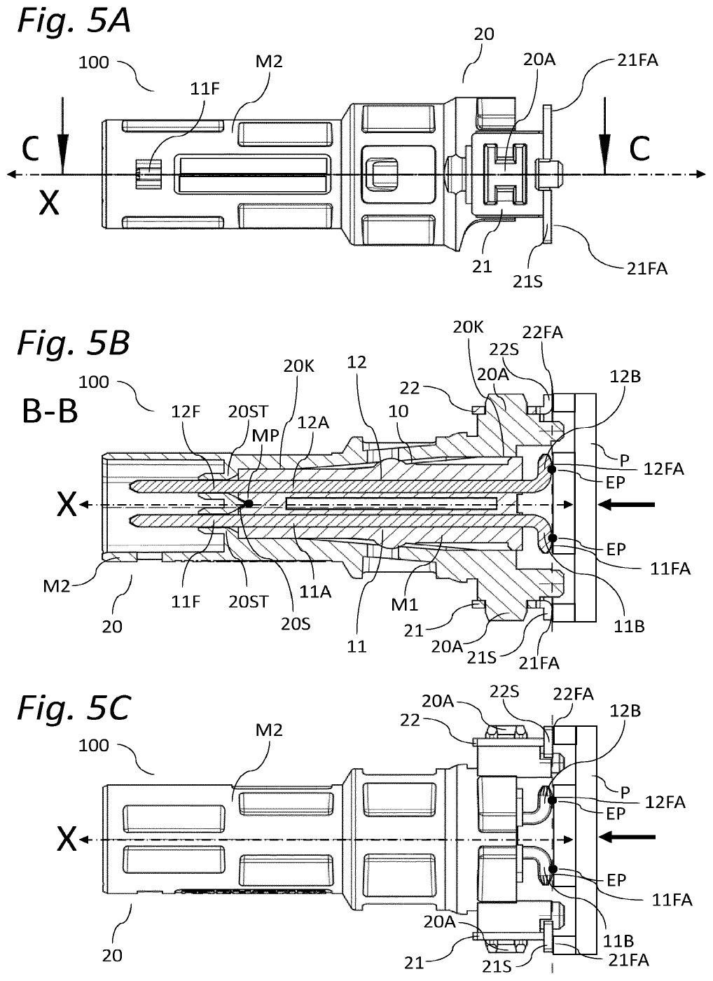

The second contact element carrier 20 is substantially designed and/or configured as a cylinder and comprises a hollow space designed as a guide channel 20K (see FIGS. 4B and 5B) for receiving the first contact element carrier 10 in the longitudinal direction X.

In order to produce the contact unit 100, a first reference contact element 21 and a second reference contact element 22 are preferably used, together with the second contact element carrier 20). Both the first reference contact element 21 and the second reference contact element 22 can preferably be designed as a shield contact element. Both the first reference contact element 21 and the second reference contact element 22 can be designed as a bent and/or punched part. It is also possible for the first reference contact element 21 and/or the second reference contact element 22 to be designed as a milling part, at least in sections.

Both the first reference contact element 21 and the second reference contact element 22 each have at least one contact element stop 21S, 22S with respective surface portions 21FA, 22FA for being contacted and actuated by means of a pressing tool P. During the production of the contact unit 100, the pressing tool P is used for positioning and/or aligning the first contact element 11 and/or the second contact element 12 in the first carrier material M1 relative to the first reference contact element 21 and/or to the second reference contact element 22, in order to ensure coplanarity of surface portions 11FA, 12FA, 21FA, and 22FA with respect to one another, and preferably while complying with required or predetermined tolerances, which will be described in more detail below. For this purpose, the pressing tool P comprises corresponding actuating surfaces which are arranged substantially coplanarly, wherein tolerances and/or geometric dimensions are substantially smaller than in the case of the (to be produced) contact unit 100.

The first reference contact element 21 and the second reference contact element 22 are each designed and/or configured for arrangement and/or releasable fastening on the second contact element carrier 20.

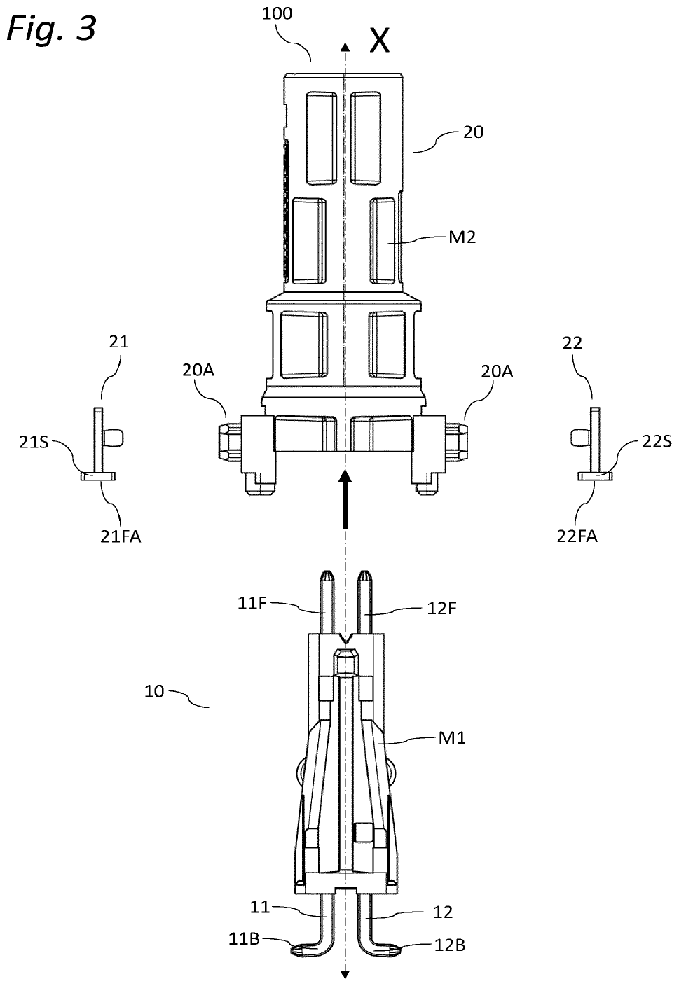

FIG. 3 shows a further exploded view of the contact unit 100 shown in FIG. 2. As is apparent from the combination of FIGS. 2 and 3, the second contact element carrier 20 is formed substantially symmetrically with respect to a plane.

FIG. 4A shows a side view of the contact unit 100 shown in FIGS. 2 and 3, wherein the contact unit 100 is in an assembly state, i.e., in a state which is not yet finished and thus produced. Thus, a state during the production of the contact unit 100 is illustrated.

FIG. 4B shows a sectional view (section B-B in FIG. 4A) of the contact unit 100 shown in FIG. 4A with a schematically illustrated pressing tool P. The first contact element carrier 10 is arranged substantially in a positive manner in a guide channel 20K of the second contact element carrier 20 of the contact unit 100, i.e., is received in the longitudinal direction X, and forms—preferably at least in sections—at least a latching connection and/or at least a crimped connection with the second contact element carrier 20. It is possible for the first contact element carrier 10 to form at least a material connection, and preferably an adhesive connection, with the second contact element carrier 20. In other words, the first contact element carrier 10 can be glued into the second contact element carrier 20, among other things.

Contact elements 11, 12 are received on their guide portions 11F, 12F in guide sleeves 20ST of the second contact element carrier 20. In other words, in each case one guide portion 11F, 12F of contact elements 11, 12 of the first contact element carrier 10 is received in sections in one guide sleeve 20ST, in each case, of the second contact element carrier 20 and penetrates it—preferably in a positive manner and/or substantially without play and/or in a clamping manner. The guide sleeves 20ST are also provided, inter alia, to hold contact elements 11, 12 and preferably guide portions 11F, 12F in a position and/or orientation.

The first contact element carrier 10 contacts a contact element carrier stop 20S in the longitudinal direction X and is thus in an assembly position MP. Therefore, contact elements 11, 12 are shown in an assembly position MP in FIGS. 4A through 4C. The pin-shaped design and/or configuration of receiving portions 11A, 12A makes it possible to press contact elements 11, 12, and to move them at least partially by means of pressing, into and/or through the overmolded and/or cast first carrier material M1 by means of pressing using a pressing tool P. The pressing tool P is shown schematically in FIGS. 4B and 4C. Preferably, the first carrier material M1 has been at least partially shrink-fitted on receiving portions 11A, 12A.

By means of pressing into an end position EP using the pressing tool P on surface portions 11FA, 12FA, it is possible, on the one hand, for contact elements 11, 12 to be arranged in an exact and/or defined position and/or orientation at the end of the production of contact unit 100. The pressing tool P moves linearly or translationally substantially in the longitudinal direction X and is operatively connected to contact elements 11, 12 via actuating portions 11B, 12B during pressing. Surface portion 12FA as well as surface portion 22FA are substantially planar or substantially flat. After contacting contact elements 11, 12 via actuating portions 11B, 12B and, here, above all via surface portions 11FA and 12FA, the pressing tool P together with contact elements 11, 12 moves substantially in the longitudinal direction X until contacting contact element stops 21S, 22S, i.e., surface portions 21FA and 22A of the first and of the second reference contact elements 21, 22.

Once contact has been achieved, surface portions 11FA, 12FA as well as 21FA and 22FA are in an end position EP and are arranged substantially coplanarly. As a result, required or predetermined tolerances can now be complied with, which characterizes the contact unit 100 of the present invention.

The process of pressing contact elements 11, 12, at least in sections, into and/or through the first carrier material M1, i.e., the overmolded and/or cast first carrier material M1, preferably takes place in a state of the first carrier material M1 shrink-fitted onto or/or on receiving portions 11A, 12A of contact elements 11, 12.

For further illustration, FIG. 4C shows a front view of the contact unit 100 shown in FIG. 4A with a schematic representation of the pressing tool P.

FIG. 5A shows a side view of the contact unit 100 shown in FIGS. 2 and 3, wherein the contact unit 100 is in a manufactured state.

FIG. 5B shows a sectional view (section C-C in FIG. 5A) of the contact unit 100 shown in FIG. 5A with the schematically illustrated pressing tool P. Contact elements 11, 12 have been subjected to pressing by the pressing tool P—more precisely, to pressing into and/or through the first carrier material M1—and are now in an end position EP relative to the first carrier material Ml of the first contact element carrier 10 and preferably relative to the respective other contact element 11, 12. In other words, contact elements 11, 12 are aligned with one another, and production-related tolerances are avoided or at least reduced primarily by an injection process and/or casting process. Furthermore, contact elements 11, 12 are positioned relative to the reference contact elements 21, 22 so that a required, so-called coplanarity tolerance can be complied with.

FIG. 5C shows, for further illustration, a front view of the contact unit 100 shown in FIGS. 5A and 5B.

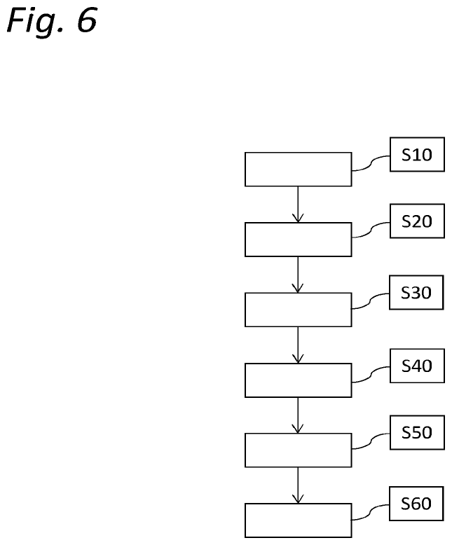

FIG. 6 shows a sequence of a first exemplary embodiment of the method according to the present invention with essential processes or process sections. It is possible that individual and/or multiple processes or process sections of the method as disclosed herein can take place simultaneously and/or in succession. Furthermore, in the context of a further exemplary embodiment of the method according to the present invention, it is possible that a second process or process section downstream of a first process or process section can take place before the first process or process section.

The method illustrated in FIG. 6 is explained by way of example with respect to the contact unit 100 with two contact elements 11, 12 and two reference contact elements 21, 22 described with reference to the preceding figures. Therefore, reference to corresponding figures is partly omitted.

The method starts in portion S10 with the provision of a first and a second contact element carrier 10, 20. The first and second contact element carriers 10, 20 are preferably designed as disclosed herein.

In process section S20, the first contact element carrier 10 is introduced, and preferably pressed, at least in sections into the second contact element carrier 20—preferably substantially in the longitudinal direction X—up to an assembly position MP of the first contact element carrier 10. Preferably, guide portions 11F, 12F of contact elements 11, 12 are inserted and/or passed through guide sleeves 20ST of the second contact element carrier 20. The first contact element carrier 10 together with the second contact element carrier 20) forms, at least in sections, at least a latching connection and/or at least a crimped connection.

In process section S30, the first and second reference contact elements 21, 22 are attached to the second contact element carrier 20 by pressing the first and second reference contact elements 21, 22 onto a respective, correspondingly configured and/or designed fastening portion 20A of the second contact element 20. The first and second reference contact elements 21, 22 are configured and/or arranged on the second contact element carrier 20 such that they protrude in the longitudinal direction X in relation to the first and second carrier materials M1, M2.

In process section S40, the first contact element 11 and the second contact element 12 of the first contact element carrier 10 are moved, and preferably pressed, substantially in the longitudinal direction X. A pressing tool P is used for this purpose, which is placed on the contact unit 100 to be produced and, above all, on contact elements 11, 12. The second contact element carrier 20 is held so that the pressing tool P can apply a resulting pressure force, substantially in the longitudinal direction X, onto contact elements 11, 12, i.e., onto actuating portions 11B, 12B with surface portions 11FA, 12FA.

In process section S50, the pressing tool P moves along the longitudinal direction X until it reaches an end position EP in which the pressing tool P contacts the first and the second contact element stops 21S, 22S, i.e., surface portions 21FA, 22FA, of the first and the second reference contact element 21, 22. Due to the corresponding design of the pressing tool P as disclosed herein, it can now be achieved that surface portions 1IFA, 12FA of contact elements 11, 12, and surface portions 21FA, 22FA of reference contact elements 21, 22 are arranged substantially coplanarly and, above all, in compliance with required or predetermined tolerances. In other words, the coplanarity of surface portions 11FA, 12FA. 21FA and 22FA can be readjusted by the pressing tool P, so that tolerances are compensated for or at least substantially minimized.

In process section S60, the contact unit 100 is fully shaped, i.e., produced, and can be used, for example, for further assembly on a printed circuit board.

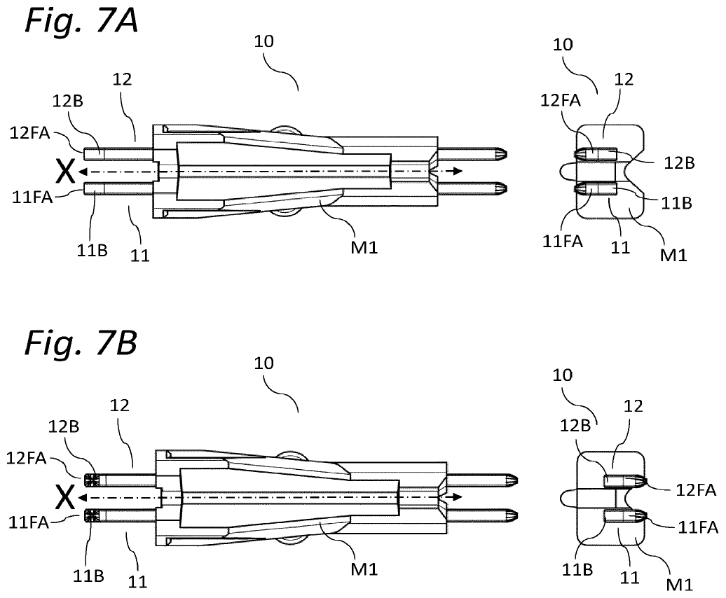

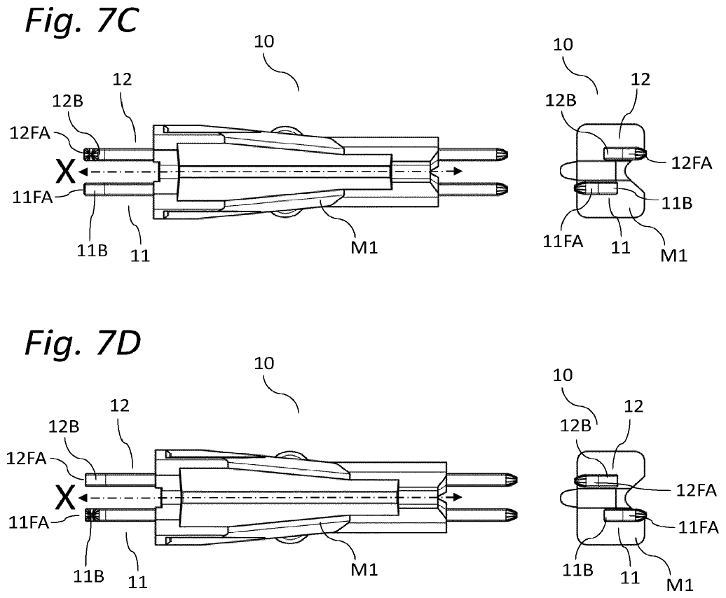

The further FIGS. 7A through 7D each show a front view and side view (side view from the left) of a first contact element carrier 10 of a second, third, fourth, and fifth exemplary embodiment of the contact unit 100 according to the present invention. Here, the respective contact elements 11, 12 with their actuating portions 11B, 12B are arranged and/or aligned correspondingly to each other.

It is possible for the actuating portions 11B, 12B to be substantially identical or at least similar to one another. It is possible for the actuating portions 11B, 12B to be arranged substantially parallel to one another, and, in the first carrier material M1, to be spaced apart from one another. Further or other configurations and orientations of actuating portions 11B, 12B and, above all, of actuating surfaces 11FA, 12FA are conceivable, but it is preferably ensured that at least one coplanar arrangement of actuating surfaces 11FA, 12FA relative to one another can be created.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

10 First contact element carrier
11 First contact element
11A Receiving portion (of the first contact element)
11B Actuating portion (of the first contact element)
11F Guide portion (of the first contact element)
12 Second contact element
12A Receiving portion (of the second contact element)
12B Actuating portion (of the second contact element)
12F Guide portion (of the second contact element)
20 Second contact element carrier
20A Fastening portion
20K Guide channel
20S Contact element carrier stop
20ST Guide sleeve
21 First reference contact element
21FA Surface portion (of the first reference contact element)
21S Contact element stop (of the first reference contact element)
22 Second reference contact element
22FA Surface portion (of the second reference contact element)
22S Contact element stop (of the second reference contact element)
100 Contact unit
EP End position
K Contour
M1 First carrier material
M2 Second carrier material
MP Assembly position
P Pressing tool
X Longitudinal direction

1. A method for producing a contact unit having at least two contact elements, comprising:
providing a first contact element carrier, which is formed from a first carrier material, such that, in the first carrier material, at least one contact element is received on a receiving portion of the at least one contact element, and the first carrier material has been at least partially shrink-fitted on the receiving portion;
providing a second contact element carrier, which is formed from a second carrier material, such that the second contact element carrier is configured to receive the first contact element carrier in a longitudinal direction;
introducing, at least in sections, the first contact element carrier into the second contact element carrier up to an assembly position of the first contact element carrier;
attaching at least one reference contact element to the second contact element carrier; and
moving the at least one contact element in the first contact element carrier to an end position, such that, in the end position, at least one surface portion of the at least one contact element and at least one surface portion of the at least one reference contact element are arranged coplanarly.

2. The method of claim 1,
wherein moving the at least one contact element comprises pressing the at least one contact element at least in sections in and/or at least in sections through the first contact element carrier by a pressing tool.

3. The method of claim 1,
wherein moving the at least one contact element is done by a pressing tool and until the pressing tool comes into contact with at least one stop, and
wherein the at least one stop is formed and/or arranged on the second contact element carrier.

4. The method claim 1,
wherein attaching the at least one reference contact element comprises pressing the at least one reference contact element at least in sections onto or at least in sections into a fastening portion of the second contact element carrier.

5. The method of claim 1,
wherein introducing, at least in sections, the first contact element carrier into the second contact element carrier comprises plugging and/or sliding the first contact element carrier along at least one guide channel of the second contact element carrier.

6. The method of claim 1, further
comprising:
forming, at least in sections, at least a nonpositive connection between the first contact element carrier and the second contact element carrier.

7. The method of claim 1, further
comprising:
forming, at least in sections, at least a positive connection between the first contact element carrier and the second contact element carrier.

8. The method of claim 1,
wherein introducing, at least in sections, the first contact element carrier into the second contact element carrier up to the assembly position comprises:
aligning a guide portion of the at least one contact element by passing the at least one contact element through at least one guide sleeve of the second contact element carrier.

9. A contact unit, comprising:
a first contact element carrier
comprising a first carrier material, such that, in the first carrier material, at least one contact element is received on a receiving portion of the at least one contact element,
wherein the first carrier material has been at least partially shrink-fitted on the receiving portion in order to support the at least one contact element in the first carrier material in a dimensionally-stable manner, and
wherein at least the receiving portion is formed in a pin-shaped and/or undercut-free manner in a longitudinal direction.

10. The contact unit of claim 9,
wherein the at least one contact element is formed in a pin-shaped and/or undercut-free manner in the longitudinal direction.

11. The contact unit of claim 9,
wherein at least the receiving portion has a rectangular, a square, a round, a trapezoidal, a triangular, an oval, or a polygonal cross-section in the longitudinal direction.

12. The contact unit of claim 9,
wherein the first contact element carrier is received in the longitudinal direction in a second contact element carrier,
wherein the second contact element carrier comprises a second carrier material on which at least one reference contact element is attached, and
wherein at least one surface portion of the at least one contact element and at least one surface portion of the at least one reference contact element are arranged coplanarly.

13. The contact unit of claim 9,
wherein the at least one contact element has an actuating portion which extends transversely to the longitudinal direction and has the at least one surface portion.

14. The contact unit of claim 9,
wherein the first contact element carrier has a first contact element and a second contact element,
wherein the first contact element is arranged at a distance from and/or opposite the second contact element, and/or the second contact element carrier has a first reference contact element and a second reference contact element, and
wherein the first reference contact element is arranged at a distance from and/or opposite the second reference contact element.

15. The contact unit of claim 9,
wherein, in the longitudinal direction, the receiving portion extends more than 70% of a total length of the at least one contact element in the longitudinal direction.

16. The method of claim 1, wherein introducing, at least in sections, the first contact element carrier into the second contact element carrier comprises introducing, at least in sections, the first contact element carrier into the second contact element carrier substantially in the longitudinal direction.

17. The method of claim 1, wherein moving the at least one contact element comprises moving the at least one contact element in the longitudinal direction.

18. The method of claim 3, wherein moving the at least one contact element comprises pressing the at least one contact element,
wherein pressing the at least one contact element is done until the pressing tool comes into contact with a surface portion of the at least one stop, and
wherein the at least one stop is formed and/or arranged on a contact element stop of the at least one reference contact element.

19. The method of claim 4, wherein attaching the at least one reference contact element comprises pressing the at least one reference contact element perpendicularly to the longitudinal direction.

20. The method of claim 5, wherein plugging and/or sliding the first contact element carrier along at least one guide channel of the second contact element carrier is in the longitudinal direction, and up to a contact element carrier stop of the second contact element carrier.
